(19) United States
(12) Patent Application Publication
(10) Pub. No.: US 2009/0301438 A1
(43) Pub. Date: Dec. 10, 2009

(54) Fuel rail of a combustion engine

(75) Inventors: Mario D'Onofrio, S. Stefano Magra (IT); Gianbattista Fischetti, Cascina (IT)

Correspondence Address: King & Spalding LLP, 401 Congress Avenue, Suite 3200, Austin, TX, 78701, US

(73) Assignee: Continental Automotive GmbH, Hannover (DE)

(21) Appl. No.: 12/421,809

(22) Filed: Apr. 10, 2009

(30) Foreign Application Priority Data
Apr. 17, 2008 (EP) EP08007522

(51) Int. Cl. F02M 69/22; F02M 69/46

(52) U.S. Cl. 123/455; 123/456

(57) ABSTRACT

A fuel rail (18) of a combustion engine (22) has a main tube (32) with a longitudinal central axis (A) and a cavity (36) forming an inner surface (38) and is designed to contain fuel, a fuel inlet portion (30) is mechanically coupled to the main tube (32), at least one fuel outlet portion (26) is mechanically coupled to the main tube (32) and is arranged hydraulically downstream the fuel inlet portion (30), and a throttle element (44) is arranged in the cavity (36) hydraulically upstream the at least one fuel outlet portion (26). The throttle element (44) comprises an outer surface (46) being at least partially distanced from the inner surface (38) thereby forming a gap (50) between the main tube (32) and the throttle element, and the throttle element and the gap are designed to compensate pressure variations of the fuel in the cavity of the main tube.

### CROSS-REFERENCE TO RELATED APPLICATIONS

This application claims priority to European Patent Application No. EP08007522, filed Apr. 17, 2008. The complete disclosure of the above-identified application is hereby fully incorporated herein by reference.

### TECHNICAL FIELD

The invention relates to a fuel rail of an internal combustion engine.

### BACKGROUND

Internal combustion engines with fuel injector assemblies are in widespread use. The fuel injector assembly can be designed to supply fuel to the internal combustion engine.

In order to keep pressure fluctuations during the operation of the internal combustion engine at a very low level, internal combustion engines are supplied with a fuel accumulator to which fuel injectors are connected and which has a relatively large volume. Such a fuel accumulator is often referred to as a fuel rail. The fuel injector assembly includes the fuel rail and the fuel injector. Known fuel rails comprise a hollow body with recesses, wherein the fuel injectors are arranged.

### SUMMARY

According to various embodiments, a fuel rail can be created which is simply to be manufactured and that enables a precise dosing of fuel.

According to an embodiment, a fuel rail of a combustion engine may comprise—a main tube with a longitudinal central axis and a cavity forming an inner surface and being designed to contain fuel,—a fuel inlet portion being mechanically coupled to the main tube,—at least one fuel outlet portion being mechanically coupled to the main tube and being arranged hydraulically downstream the fuel inlet portion, and—a throttle element being arranged in the cavity hydraulically upstream the at least one fuel outlet portion, wherein the throttle element comprises an outer surface being at least partially distanced from the inner surface thereby forming a gap between the main tube and the throttle element, and the throttle element and the gap are designed to compensate pressure variations of the fuel in the cavity of the main tube.

According to a further embodiment, at least two fuel outlet portions can be mechanically coupled to the main tube and can be arranged hydraulically serial downstream the fuel inlet portion, and one of a plurality of throttle elements each can be hydraulically arranged between two of the fuel outlet portions. According to a further embodiment, a carrier element can be arranged in the cavity and can be fixedly coupled to the throttle element and to the main tube. According to a further embodiment, the main tube may be of a cylindrical shape and the throttle element may have a disc shape. According to a further embodiment, the gap can be an annular gap. According to a further embodiment, the carrier element can be shaped as a rod and may extend in direction of the longitudinal central axis. According to a further embodiment, the carrier element can be coupled to the fuel inlet portion. According to a further embodiment, the fuel inlet portion can eb arranged at a first axial end of the main tube and the carrier element can be coupled to a second axial end opposing the first axial end of the main tube.

### BRIEF DESCRIPTION OF THE DRAWINGS

Exemplary embodiments of the invention are explained in the following with the aid of schematic drawings. These are as follows:

FIG. 1 an internal combustion engine with a fuel rail in a schematic view,

FIG. 2 a longitudinal section through the fuel rail in a schematic view, and

FIG. 3 parts of the fuel rail in a side view.

Elements of the same design and function that occur in different illustrations are identified by the same reference character.

### DETAILED DESCRIPTION

According to various embodiments, a fuel rail of a combustion engine may comprise a main tube with a longitudinal central axis and a cavity forming an inner surface and being designed to contain fuel, a fuel inlet portion being mechanically coupled to the main tube, at least one fuel outlet portion being mechanically coupled to the main tube and being arranged hydraulically downstream the fuel inlet portion, and a throttle element being arranged in the cavity hydraulically upstream the at least one fuel outlet portion. The throttle element comprises an outer surface being at least partially distanced from the inner surface thereby forming a gap between the main tube and the throttle element. The throttle element and the gap are designed to compensate pressure variations of the fuel in the cavity of the main tube.

The gap between the main tube and the throttle element is designed to enable a fuel flow from the fuel inlet portion to the fuel outlet portion.

The gap between the main tube and the throttle element may have the advantage that it is possible to obtain a damping of the pressure variations in the fuel outlet portion. This makes it possible to balance pressure changes of the fuel in the cavity of the main tube and to avoid unwanted oscillations of the mass flow rate in injectors coupled to the fuel outlet portions of the fuel rail. Consequently, repeatable and precise quantities of fuel for the injectors are possible.

In an embodiment of the fuel rail at least two fuel outlet portions are mechanically coupled to the main tube and are arranged hydraulically serial downstream the fuel inlet portion. One of a plurality of throttle elements each is hydraulically arranged between two of the fuel outlet portions. This may have the advantage that balancing of the pressure changes and avoiding unwanted oscillations of the mass flow rate for each of the fuel outlet portions is possible.

In a further embodiment of the fuel rail a carrier element is arranged in the cavity and is fixedly coupled to the throttle element and to the main tube. By this a simple possibility to determine the position of the throttle element relative to the main tube is obtained. Consequently, it is possible to determine the structure of the gap between the throttle element and the main tube.

In a further embodiment of the fuel rail the main tube has a cylindrical shape and the throttle element has a disc shape. By this the shape of the throttle element can be adapted to a cylindrical main tube.

In a further embodiment of the fuel rail the gap is an annular gap. A gap of an annular shape may enable an advantageous fluid characteristic of the fuel passing the throttle through the gap.

In a further embodiment of the fuel rail the carrier element is shaped as a rod and extends in direction of the longitudinal central axis. This may have the advantage that good fuel flow characteristics are possible. Furthermore, a simple construction of the carrier element is possible.

In a further embodiment of the fuel rail the carrier element is coupled to the fuel inlet portion. This may have the advantage that the carrier element with the throttle element can be coupled to the main tube together with the fuel inlet portion. A simple construction of the fuel rail with the fuel inlet portion and the carrier element with the throttle elements is possible.

In a further embodiment of the fuel rail the fuel inlet portion is arranged at a first axial end of the main tube and the carrier element is coupled to a second axial end opposing the first axial end of the main tube. This is a simple manner to determine the position of the carrier element with the throttle element relative to the main tube.

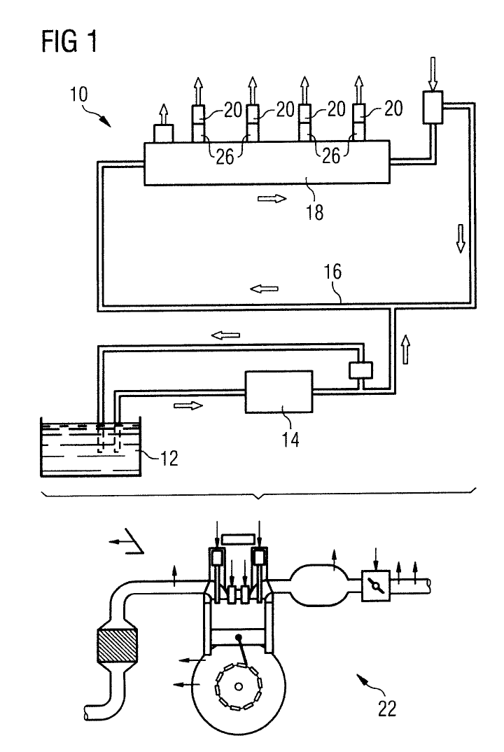

FIG. 1 shows a fuel feed device 10 which is assigned to an internal combustion engine 22 of a vehicle. It includes a fuel tank 12 that is connected via a fuel line to a low-pressure pump 14. The output of the low-pressure pump 14 is connected to a fuel inlet 16 of a fuel rail 18. The fuel rail 18 has fuel outlet portions 26. Fuel injectors 20 are connected to the fuel outlet portions 26 of the fuel rail 18. The fuel is fed to the fuel injectors 20 via the fuel rail 18. The fuel injectors 20 have a sealed connection to the fuel rail 18.

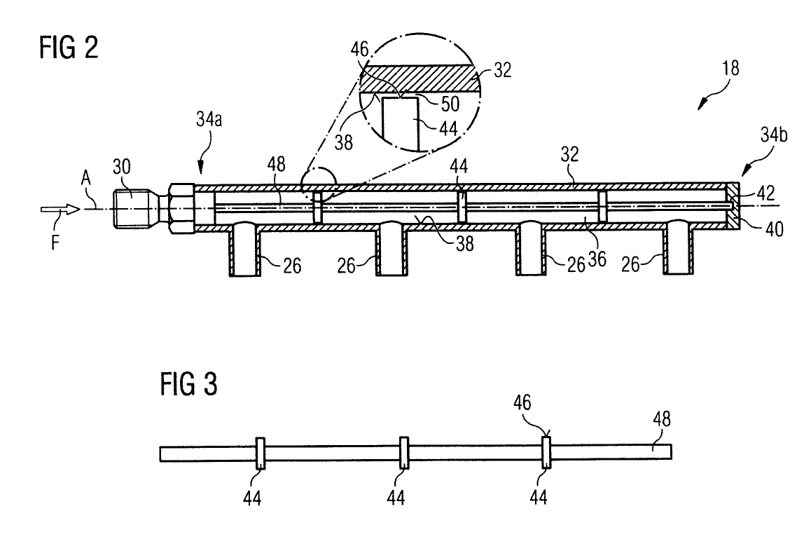

FIG. 2 shows a detailed longitudinal section through the fuel rail 18. The fuel rail 18 has a main tube 32 with a first axial end 34a and a second axial end 34b. The fuel outlet portions 26 interact with the fuel injectors 20 to sealingly engage the fuel injectors 20 into the fuel outlet portions 26. Preferably, the fuel outlet portions 26 are of a material comprising stainless steel.

The fuel rail 18 comprises a fuel inlet portion 30 which is preferably arranged at the first axial end 34a of the main tube 32 of the fuel rail 18. In further embodiments the fuel inlet portion 30 is arranged at the main tube 32 between its first axial end 34a and its second axial end 34b.

The main tube 32 of the fuel rail 18 has a cavity 36 which forms an inner surface 38 of the main tube 32. The cross section of the main tube 32 can be of any shape, in particular of a circular or a square shape. The main tube 32 has a longitudinal central axis A and is designed to contain fuel.

The fuel rail 18 has an end cap 40 which is preferably fixedly coupled to the second axial end 34b of the main tube 32. Preferably, the end cap 40 is coupled to the main tube 32 by welding or brazing. This makes it possible to sealingly close the cavity 36 of the main tube 32 in a secure manner. The end cap 40 comprises a recess 42 which function will be explained in the following.

Throttle elements 44 are arranged in the cavity 36 of the main tube 32. Each of the throttle elements 44 is arranged hydraulically upstream one of the fuel outlet portions 26. By this one of the throttle elements 44 is arranged hydraulically between two of the fuel outlet portions 26. The throttle elements 44 have a disk shape and comprise an outer surface 46.

A gap 50 is formed between the outer surface 46 of the throttle element 44 and the inner surface 38 of the main tube 32. The gap 50 forms a distance between the inner surface 38 of the cavity 36 and the outer surface 46 of the throttle elements 44. The gap 50 forms a narrow point for the fuel flow from the fuel inlet portion 30 to the fuel outlet portion 26 and can compensate pressure variations of the fuel in the cavity 36 of the main tube 32.

The throttle elements 44 are fixedly coupled to a carrier element 48 which is arranged in the cavity 36. The carrier element 48 has the shape of a rod and extends in the direction of the longitudinal central axis A. The carrier element 48 is fixedly coupled to the main tube 32, preferably in the recess 42 of the end cap 40. Further, the carrier element 48 is coupled to the fuel inlet portion 30. Coupling the carrier element 48 to the fuel inlet portion 30 and to the recess 42 of the end cap 40 allows to determine the position of the throttle elements 44 relative to the main tube 32. Furthermore, the shape of the gap 50 between the throttle element 44 and the main tube 32 can be determined very simple. In particular, it is very simple to obtain an annular shape of the gap 50.

The carrier element 48 and the throttle elements 44 are preferably of a material containing a metal and the carrier element 48 is preferably fixed to the throttle elements 44 by welding a brazing.

In a further embodiment, the carrier element 48 and the throttle elements 44 are of a material comprising plastics.

The use of the throttle elements 44 in the cavity 36 of the main tube 32 may have the advantage that the statistic spread of the injection volumes of the fuel injectors 20 caused by the pressure waves in the cavity 36 of the main tube 32 can be kept small.

In the following, the function of the fuel rail 18 will be described in detail:

The fuel enters the fuel rail 18 at the fuel inlet portion 30 in a fuel flow direction F, passes the gaps 50 between the throttle elements 44 and the main tube 32 and leaves the fuel rail 18 through the fuel inlet portion 30 in direction to the fuel injectors 20. This operation can cause pressure changes in the cavity 36 of the main tube 32 depending on the opening and the closing of the fuel injectors 20.

The throttle elements 44 facilitate that the injection pressure of all the injectors 20 is basically identical. Pressure changes of the fuel in the cavity 36 of the main tube 32 can be balanced by the throttle elements 44 and the gaps 50 between the throttle elements 44 and the main tube 32 and unwanted oscillations of the mass flow rate in the fuel injectors 20 coupled to the fuel outlet portions 26 of the fuel rail 18 can be avoided.

The reduction of the pressure peaks inside the main tube 32 and the further components of the fuel rail 18 enables a longer life time of the components of the fuel feed device 10.

What is claimed is:

1. A fuel rail of a combustion engine comprising
a main tube with a longitudinal central axis and a cavity forming an inner surface and being designed to contain fuel,
a fuel inlet portion being mechanically coupled to the main tube,
at least one fuel outlet portion being mechanically coupled to the main tube and being arranged hydraulically downstream the fuel inlet portion, and
a throttle element being arranged in the cavity hydraulically upstream the at least one fuel outlet portion, wherein
the throttle element comprises an outer surface being at least partially distanced from the inner surface thereby forming a gap between the main tube and the throttle element, and the throttle element and the gap are operable to compensate pressure variations of the fuel in the cavity of the main tube.

2. The fuel rail according to claim 1, wherein at least two fuel outlet portions being mechanically coupled to the main tube and arranged hydraulically serial downstream the fuel inlet portion, and one of a plurality of throttle elements each being hydraulically arranged between two of the fuel outlet portions.

3. The fuel rail according to claim 1, wherein a carrier element being arranged in the cavity and being fixedly coupled to the throttle element and to the main tube.

4. The fuel rail according to claim 1, wherein the main tube having of a cylindrical shape and the throttle element having a disc shape.

5. The fuel rail according to claim 1, wherein the gap being an annular gap.

6. The fuel rail according to claim 3, wherein the carrier element being shaped as a rod and extending in direction of the longitudinal central axis.

7. The fuel rail according to claim 3, wherein the carrier element being coupled to the fuel inlet portion.

8. The fuel rail according to claim 3, wherein the fuel inlet portion being arranged at a first axial end of the main tube and the carrier element being coupled to a second axial end opposing the first axial end of the main tube.

9. A method for providing fuel for a combustion engine comprising the steps of:
arranging a main tube with a longitudinal central axis and a cavity forming an inner surface,
coupling a fuel inlet portion mechanically to the main tube,
coupling at least one fuel outlet portion mechanically to the main tube and arranging the at least one fuel outlet portion hydraulically downstream the fuel inlet portion, and
arranging a throttle element in the cavity hydraulically upstream the at least one fuel outlet portion, wherein the throttle element comprises an outer surface being at least partially distanced from the inner surface thereby forming a gap between the main tube and the throttle element, and the throttle element and the gap are operable to compensate pressure variations of the fuel in the cavity of the main tube.

10. The method according to claim 9, further comprising the step of coupling at least two fuel outlet portions mechanically to the main tube and arranging the at least two fuel outlet portions hydraulically serial downstream the fuel inlet portion, and arranging one of a plurality of throttle elements hydraulically between two of the fuel outlet portions.

11. The method according to claim 9, further comprising the step of arranging a carrier element in the cavity and fixedly coupling the carrier element to the throttle element and to the main tube.

12. The method according to claim 9, wherein the main tube having of a cylindrical shape and the throttle element having a disc shape.

13. The method according to claim 9, wherein the gap being an annular gap.

14. The method according to claim 11, wherein the carrier element being shaped as a rod and extending in direction of the longitudinal central axis.

15. The method according to claim 11, further comprising the step of coupling the carrier element to the fuel inlet portion.

16. The method according to claim 11, further comprising the step of arranging the fuel inlet portion at a first axial end of the main tube and coupling the carrier element to a second axial end opposing the first axial end of the main tube.
